(19) United States
(12) Patent Application Publication
(10) Pub. No.: US 2011/0127974 A1
(43) Pub. Date: Jun. 2, 2011

(54) SWITCHING CONTROL CIRCUIT AND POWER SUPPLY APPARATUS

(75) Inventor: Iwao Fukushi, Ora-Gun (JP)

(73) Assignees: SANYO ELECTRIC CO., LTD., Osaka (JP); SANYO SEMICONDUCTOR CO., LTD., Ora-Gun (JP)

(21) Appl. No.: 12/955,706

(22) Filed: Nov. 29, 2010

(30) Foreign Application Priority Data
Nov. 27, 2009 (JP) 2009-270586

(51) Int. Cl. G05F 1/10

(52) U.S. Cl. 323/271

(57) ABSTRACT

A switching control circuit includes: a drive circuit configured to turn on/off a transistor according to a duty ratio of a drive signal so as to generate an output voltage of a target level from an input voltage, the transistor configured to be applied with the input voltage at an input electrode thereof; and a drive signal generation circuit configured to change the duty ratio of the drive signal based on a reference voltage and a feedback voltage corresponding to the output voltage, to generate the drive signal having the duty ratio which is changed so that the feedback voltage becomes equal in level to the reference voltage, and which is changed so that the output voltage is reduced with a rise in temperature.

### CROSS-REFERENCE TO RELATED APPLICATION

This application claims the benefit of priority to Japanese Patent Application No. 2009-270586, filed Nov. 27, 2009, of which full contents are incorporated herein by reference.

### BACKGROUND OF THE INVENTION

1. Field of the Invention

The present invention relates to a switching control circuit and a power supply apparatus.

2. Description of the Related Art

An integrated circuit such as a power supply IC is generally provided with an overheat protection circuit for preventing the thermal destruction of a power supply IC. The overheat protection circuit stops the switching operation of the power supply IC when the power supply IC reaches a predetermined temperature, for example. This enables the overheat protection circuit to suppress further heat generation of the power supply IC so that the thermal destruction of the power supply IC is prevented (see, e.g., Japanese Laid-Open Patent Publication No. 2003-108241).

If an output current which is supplied from the power supply IC to a load is transiently increased, the temperature of the power supply IC abruptly rises in accordance with the increase in the output current. When the temperature of the power supply IC reaches a predetermined temperature, the overheat protection circuit is activated to stop the supply of the output current. In general, if the output current abruptly increases in a state where the ambient temperature of the power supply IC is high, the possibility that the power supply IC exceeds the predetermined temperature becomes high. Thus, there is such a problem that the number of times the generation of the output current is stopped is increased so that the power supply IC has difficulty in driving the load in a stable manner.

### SUMMARY OF THE INVENTION

A switching control circuit according to an aspect of the present invention, includes: a drive circuit configured to turn on/off a transistor according to a duty ratio of a drive signal so as to generate an output voltage of a target level from an input voltage, the transistor configured to be applied with the input voltage at an input electrode thereof; and a drive signal generation circuit configured to change the duty ratio of the drive signal based on a reference voltage and a feedback voltage corresponding to the output voltage, to generate the drive signal having the duty ratio which is changed so that the feedback voltage becomes equal in level to the reference voltage, and which is changed so that the output voltage is reduced with a rise in temperature.

Other features of the present invention will become apparent from descriptions of this specification and of the accompanying drawings.

### BRIEF DESCRIPTION OF THE DRAWINGS

For more thorough understanding of the present invention and advantages thereof, the following description should be read in conjunction with the accompanying drawings, in which:

FIG. 1 is a diagram illustrating a configuration of a switching power supply circuit 10 according to one embodiment of the present invention;

FIG. 2 is a diagram for explaining an operation of a switching power supply circuit 10;

FIG. 3 is a diagram for explaining an operation of a switching power supply circuit 10 when a temperature changes;

FIG. 4 is a diagram illustrating a configuration of a switching power supply circuit 12;

FIG. 5 is a diagram for explaining operations of switching power supply circuits 10, 12 when a state of a load 11 changes;

FIG. 6 is a diagram illustrating waveforms of main signals in a switching power supply circuit 12 when an overheat protection circuit 51 is activated;

FIG. 7 is a diagram illustrating a configuration of a switching power supply circuit 15 according to one embodiment of the present invention;

FIG. 8 is a diagram for explaining an operation of a switching power supply circuit 15;

FIG. 9 is a diagram for explaining an operation of a switching power supply circuit 15 when a temperature changes;

FIG. 10 is a diagram illustrating a configuration of a power supply apparatus 100, 150 according to one embodiment of the present invention;

FIG. 11 is a diagram for explaining an operation of a power supply apparatus 100;

FIG. 12 is a diagram for explaining an operation of a power supply apparatus 150; and

FIG. 13 is a diagram illustrating a configuration of a power supply apparatus 200, 250 according to one embodiment of the present invention.

### DETAILED DESCRIPTION OF THE INVENTION

At least the following details will become apparent from descriptions of this specification and of the accompanying drawings.

### First Embodiment of Switching Power Supply Circuit

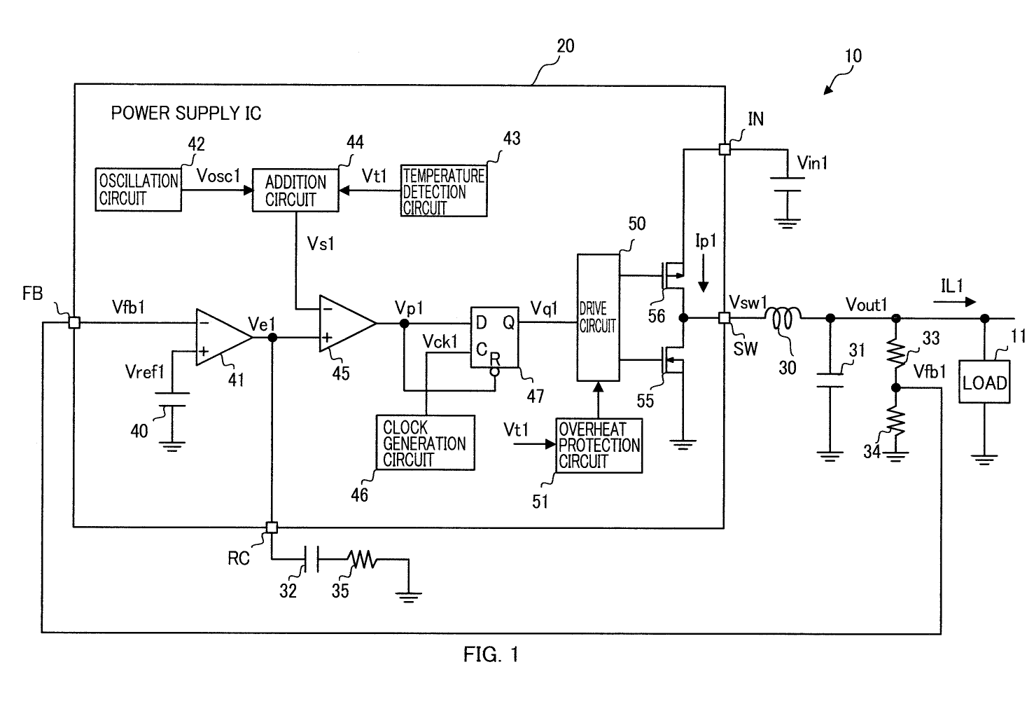

FIG. 1 depicts a configuration of a switching power supply circuit 10 according to one embodiment of the present invention. The switching power supply circuit 10 is a circuit that generates a desired output voltage Vout1 from an input voltage Vint, and includes a power supply IC 20, an inductor 30, capacitors 31, 32, and resistors 33 to 35, for example.

A load 11 is an integrated circuit such as CPU (Central Processing Unit), for example, and operates with the output voltage Vout1 used as a power supply voltage. A load current flowing through the load 11 is referred to as IL1.

The power supply IC 20 (switching control circuit) includes a reference voltage circuit 40, an error amplification circuit 41, an oscillation circuit 42, a temperature detection circuit 43, an addition circuit 44, a comparator 45, a clock generation circuit 46, a D-flip-flop 47, a drive circuit 50, an overheat protection circuit 51, an NMOS transistor 55, and a PMOS transistor 56. The power supply IC 20 is an integrated circuit including a terminal IN, a terminal SW, a terminal RC, and a terminal FB. The power supply IC 20 generates the output voltage Vout1 of a target level by switching the NMOS transistor 55 and the PMOS transistor 56 so that a voltage Vfb1 applied to the terminal FB is set at a predetermined level. The reference voltage circuit 40, the error amplification circuit 41, the oscillation circuit 42, the temperature detection circuit 43, the addition circuit 44, the comparator 45, the clock generation circuit 46, and the D-flip-flop 47 correspond to a drive signal generation circuit. The oscillation circuit 42, the temperature detection circuit 43, and the addition circuit 44 correspond to an oscillation signal output circuit. The comparator 45, the clock generation circuit 46, and the D-flip-flop 47 correspond to a drive signal output circuit.

The reference voltage circuit 40 is a circuit that generates a reference voltage Vref1 of a predetermined level independent of temperature, such as bandgap voltage, for example.

The error amplification circuit 41 is a circuit that amplifies an error between the feedback voltage Vfb1 applied to the terminal FB and the reference voltage Vref1. The capacitor 32 and the resistor 35 for phase compensation are connected between the output of the error amplification circuit 41 and a ground GND via the terminal RC. A voltage of a node connecting the output of the error amplification circuit 41 and the terminal RC is referred to as a voltage Ve1.

The oscillation circuit 42 outputs a sawtooth oscillation signal Vosc1 with a predetermined period.

The temperature detection circuit 43 (temperature voltage generation circuit) outputs a temperature voltage Vt1 having a voltage level which is changed with a temperature Tx1 of the power supply IC 20. The temperature Tx1 is determined by a sum of the generated heat generated at the circuits of the power supply IC 20 and an ambient temperature Ta around the power supply IC 20. In an embodiment of the present invention, the temperature detection circuit 43 is designed such that the temperature voltage Vt1 is increased as a temperature rises.

The addition circuit 44 adds the voltage level of the oscillation signal Vosc1 and the voltage level of the temperature voltage Vt1. The addition circuit 44 outputs an addition result as a voltage Vs1.

The comparator 45 compares the voltage Ve1 with the voltage Vs1 and output a PWM signal Vp1. The voltage Ve1 is applied to a non-inverting input terminal of the comparator 45 and the voltage Vs1 is applied to an inverting input terminal of the comparator 45. Therefore, if the voltage Vs1 becomes lower in level than the voltage Ve1, the PWM signal Vp1 goes high and if the voltage Vs1 becomes higher in level than the voltage Ve1, the PWM signal Vp1 goes low. Hereinafter, in an embodiment of the present invention, a high-level period relative to one period in the PWM signal Vp1 is represented by a duty ratio of the PWM signal Vp1.

The clock generation circuit 46 outputs a clock signal Vck1 that goes high in such timing that the oscillation signal Vosc1 changes from a falling edge to a rising edge.

The D-flip-flop 47 synchronizes the PWM signal Vp1 from the comparator with the clock signal Vck1 and change a drive signal Vq1. If the PWM signal Vp1 is high, the drive signal Vq1 goes high on the rising edge of the clock signal Vck1, and if the PWM signal Vp1 is low, the D-flip-flop 47 is reset and the drive signal Vq1 goes low.

The drive circuit 50 executes switching for the NMOS transistor 55 and the PMOS transistor 56 based on the drive signal Vq1. Specifically, when the drive signal Vq1 goes high, the NMOS transistor 55 is turned off and the PMOS transistor 56 is turned on. When the drive signal Vq1 goes low, the NMOS transistor 55 is turned on and the PMOS transistor 56 is turned off.

The overheat protection circuit 51 stops the switching of the drive circuit 50 when the temperature Tx1 of the power supply IC 20 reaches a predetermined temperature To based on the temperature voltage Vt1. When the temperature Tx1 reaches the temperature To, the overheat protection circuit 51 causes the drive circuit 50 to turn off the NMOS transistor 55 and the PMOS transistor 56.

The NMOS transistor 55 and the PMOS transistor 56 are synchronous rectifier circuits. When the drive circuit 50 turns on the NMOS transistor 55 and turns off the PMOS transistor 56, a level of the voltage of the terminal SW becomes substantially a level of the ground GND. Thus, the capacitor 31 is discharged and the output voltage Vout1 is reduced. On the other hand, when the drive circuit 50 turns off the NMOS transistor 55 and turns on the PMOS transistor 56, the voltage of the terminal SW is set approximately at the input voltage Vin. Thus, the capacitor 31 is charged and the output voltage Vout1 is increased. In the power supply IC 20, as is the case with other typical power supply ICs, the greatest amount of heat is generated by the PMOS transistor 56 that outputs a current serving as the load current IL1. Therefore, when the on-resistance of the PMOS transistor 56 is referred to as Rp and the current of the PMOS transistor 56 is referred to as Ip1, the generated heat of the power supply IC 20 changes according to Rp×Ip1², which is the generated heat in the PMOS transistor 56. The source electrode of the PMOS transistor 56 corresponds to an input electrode.

The inductor 30 and the capacitor 31 make up a low-pass filter that attenuates a high-frequency component of a voltage Vsw of the terminal SW. Therefore, the direct-current level output voltage Vout1 is generated in the capacitor 31.

The resistor 33 and the resistor 34 generate the feedback voltage Vfb1 acquired by dividing the output voltage Vout1 by a resistance ratio between the resistors 33 and 34.

### Operation of Switching Power Supply Circuit 10 in Constant Temperature

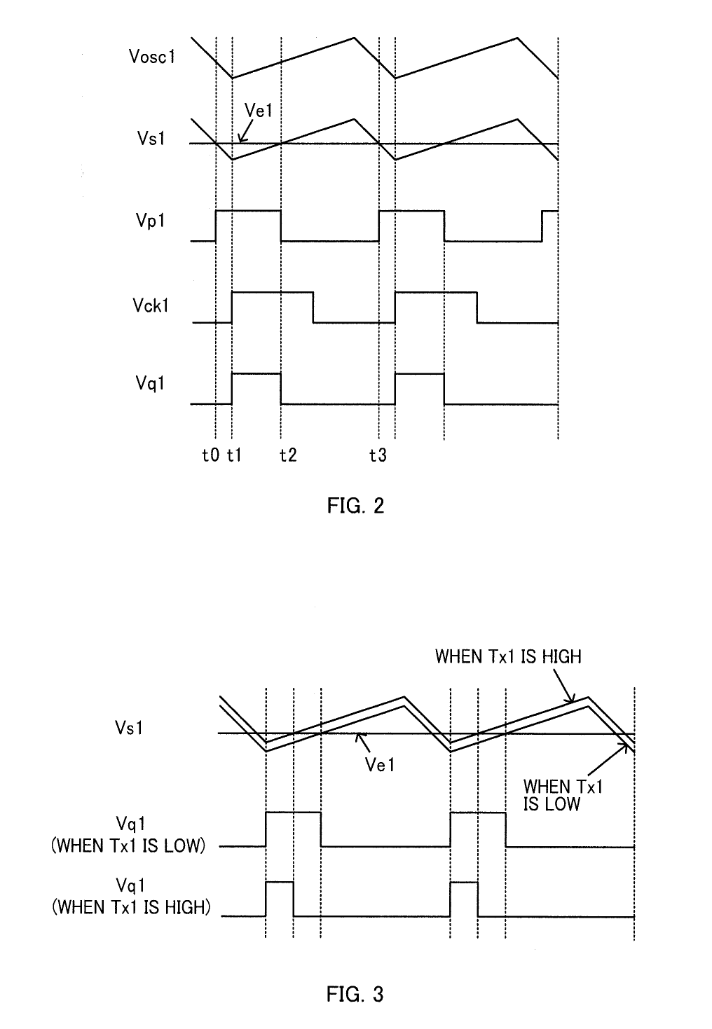

A description will be given of an operation of the switching power supply circuit 10 when the temperature Tx1 of the power supply IC 20 is constant, with reference to FIG. 2. Since it is assumed that the temperature Tx1 of the power supply IC 20 is constant, the voltage Vt1 and the direct-current level of the voltage Vs1 are constant. In this case, the voltage Vs1 changes in the same manner as is the case with the oscillation signal Vosc1. It is also assumed that the switching power supply circuit 10 generates the output voltage Vout1 of a desired level.

When the voltage Vs1 becomes lower than the voltage Ve1 at time t0, the PWM signal Vp1 goes high. When the clock signal Vck1 goes high at time t1 at which the oscillation signal Vosc1 rises, the drive signal Vq1 goes high. Therefore, the NMOS transistor 55 is turned off and the PMOS transistor 56 is turned on.

When the voltage Vs1 becomes higher than the voltage Ve1 at time t2, the PWM signal Vp1 goes low. As a result, the D-flip-flop 47 is reset and the drive signal Vq1 goes low. Therefore, the NMOS transistor 55 is turned on and the PMOS transistor 56 is turned off. When the voltage Vs1 becomes lower than the voltage Ve1 at time t3, the PWM signal Vp1 goes high as is the case with time t0. The operation from time t0 to t3 is repeated after time t3.

For example, if the output voltage Vout1 is increased, the feedback voltage Vfb1 is also increased. If the feedback voltage Vfb1 becomes greater than the reference voltage Vref1, the voltage Ve1 is reduced and the duty ratio of the drive signal Vq1 is also reduced. Therefore, the increased output voltage Vout1 and feedback voltage Vfb1 are reduced. On the other hand, if the output voltage Vout1 is reduced, the feedback voltage Vfb1 is also reduced. If the feedback voltage Vfb1 becomes smaller than the reference voltage Vref1, the voltage Ve1 is increased and the duty ratio of the drive signal Vq1 is also increased. Therefore, the reduced output voltage Vout1 and feedback voltage Vfb1 are increased. As such, the feedback voltage Vfb1 is in the feedback control so as to become equal to the reference voltage Vref1, and the power supply IC 20 continuously generates the desired voltage Vout1.

### Operation of Switching Power Supply Circuit 10 in Gradually Changing Temperature

A description will be given of an operation of the switching power supply circuit 10 when the temperature of the power supply IC 20 gradually changes. The gradual change in temperature indicates that the temperature Tx1 of the power supply IC 20 changes more slowly, to a sufficient degree, as compared to a response speed in a loop band of a feedback loop of the feedback voltage Vfb1. It is assumed that the switching power supply circuit 10 generates the output voltage Vout1 of a desired level. The response speed in the loop band of the feedback loop of the feedback voltage Vfb1 is hereinafter simply referred to as a response speed of the switching power supply circuit 10.

For example, if the ambient temperature Ta rises, the temperature Tx1 of the power supply IC 20 also rises. Therefore, the temperature voltage Vt1 is increased and the direct-current level of the voltage Vs1 is also increased. If the direct-current level of the voltage Vs1 is increased, the duty ratio of the drive signal Vq1 is reduced as exemplified in FIG. 3. If the duty ratio of the drive signal Vq1 is reduced, the output voltage Vout1 is reduced and therefore the feedback voltage Vfb1 is also reduced. As described above, the feedback voltage Vfb1 is in the feedback control so as to become equal to the reference voltage Vref1. An embodiment of the present invention is designed such that the response speed of the switching power supply circuit 10 becomes faster, to a sufficient degree, than the change in the ambient temperature Ta. Therefore, if the direct current level of the voltage Vs1 is increased and the feedback voltage Vfb1 is reduced, the power supply IC 20 immediately increases the level of the voltage Ve1 so that the feedback voltage Vfb1 becomes equal to the reference voltage Vref1. Thus, in an embodiment of the present invention, the duty ratio of the drive signal Vq1 does not substantially change and the duty ratio of the drive signal Vq1 is kept constant. The same applies to the case where the ambient temperature Ta falls. As such, if a change in temperature is gradual, the switching power supply circuit 10 continuously generates the desired output voltage Vout1.

### Operation of Switching Power Supply Circuit 10 in Abruptly Changing Temperature

A description will be given of an operation of the switching power supply circuit 10 when the temperature of the power supply IC 20 abruptly changes. The abrupt change in temperature indicates that the temperature Tx1 of the power supply IC 20 changes at a non-negligible speed relative to the response speed of the switching power supply circuit 10.

If the temperature Tx1 abruptly rises, the duty ratio of the drive signal Vq1 is reduced as exemplified in FIG. 3. Therefore, the ON-period of the PMOS transistor 56 becomes shorter and the current Ip1 supplied from the PMOS transistor 56 to the terminal SW is reduced. Since the temperature Tx1 changes with the current Ip1 as described above, if the temperature Tx1 abruptly rises, the rise in the temperature Tx1 is consequently suppressed. On the other hand, if the temperature Tx1 abruptly falls, the duty ratio of the drive signal Vq1 is increased. Therefore, the ON-period of the PMOS transistor 56 becomes longer and the current Ip1 is increased. That is, if the temperature Tx1 abruptly falls, the fall in the temperature Tx1 is consequently suppressed. As such, if the temperature Tx1 abruptly changes, the switching power supply circuit 10 operates in such a manner as to prevent the change in the temperature Tx1.

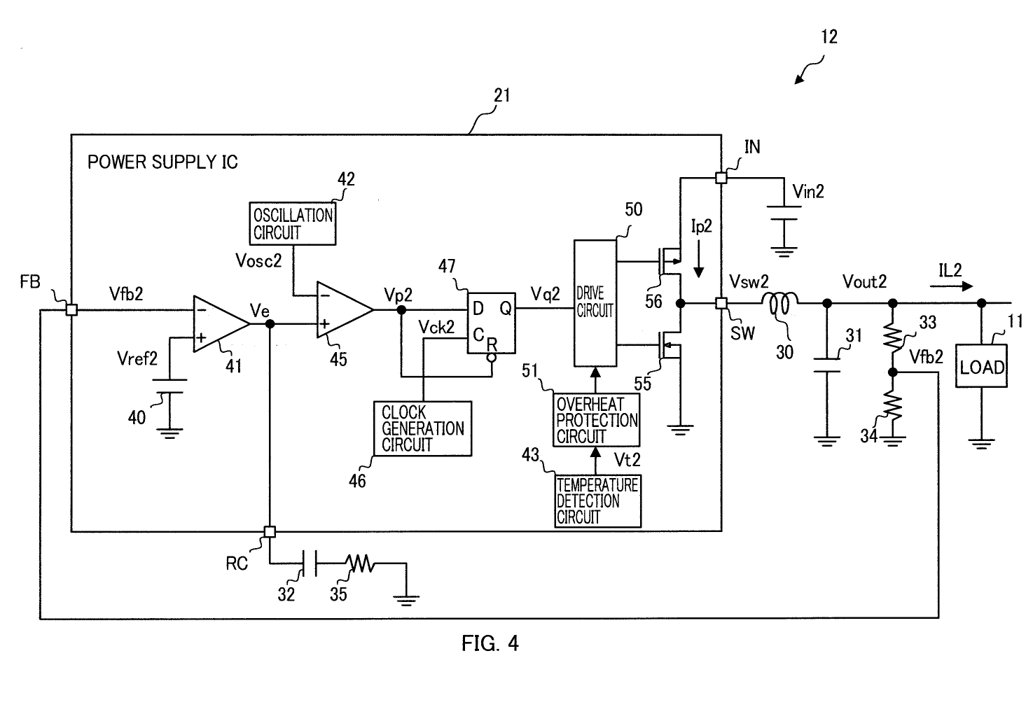

A detailed description will be given of an operation of the switching power supply circuit 10 in comparison with an operation of a typical switching power supply circuit. The typical switching power supply circuit is provided as a switching power supply circuit 12 using a power supply IC 21 as depicted in FIG. 4, for example. The power supply IC 21 has a configuration where an oscillation signal Vosc2 of the oscillation circuit 42 is applied to the non-inverting input terminal of the comparator 45 without the addition circuit 44 being provided in the power supply IC 20. The components equivalent to those in the power source IC 20 are designated by the same reference numerals in the power supply IC 21. The voltages, etc., of the nodes equivalent to those in the power source IC 20 are designated by the same reference numerals in the power source IC 21. Since the power source IC 21 has a configuration similar to that of the power source IC 20 except the addition circuit 44, etc., the direct current level of the oscillation signal Vosc2 in the power source IC 21 is constant regardless of change in temperature. Therefore, as is the case with the switching power supply circuit 10 in such a case that the temperature Tx1 is constant, the switching power supply circuit 12 controls an output voltage Vout2 so that a feedback voltage Vfb2 becomes equal to a reference voltage Vref2. It should be noted here that the temperature of the power source IC 21 is referred to as Tx2.

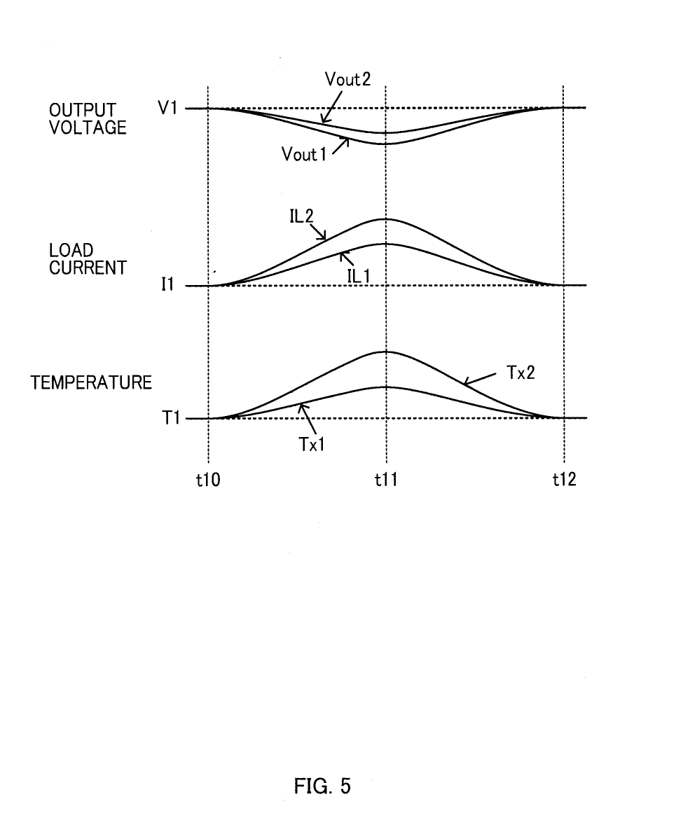

FIG. 5 depicts an example of a change in a load current, etc., when the load 11 transiently changes. It is assumed that the output voltages Vout1, Vout2 are set at a desired voltage V1 at time t10 before the change in the load 11. It is also assumed that the load currents IL1, IL2 are set at a current I1 and that the temperature Tx1, Tx2 are set at a temperature T1. In FIG. 5, the load 11 becomes heavier from time t10 to time t11, and thereafter, it becomes lighter from time t11 to time t12. The load 11 changes in state so as to become in the same state, at time t12, as the load 11 at time t10. It is assumed, in an embodiment of the present invention, that the speed with which the load 11 changes in state is faster than the response speed of the switching power supply circuit 10, 12.

A description will be given of waveforms of the switching power supply circuit 12. As described above, since the load 11 changes in state faster than the response speed of the switching power supply circuit 12, the output voltage Vout2 is reduced as the load 11 becomes heavier and is increased as the load 11 becomes lighter. Since the load 11 is heaviest at time t11, the load current IL2 becomes the greatest at time t11. When the output voltage Vout2 is reduced from the voltage V1, the switching power supply circuit 12 allows the ON-period of the PMOS transistor 56 to become longer to increase the output voltage Vout2. The ON-period of the PMOS transistor 56 becomes longer as the output voltage Vout2 is reduced from the voltage V1. Therefore, the current Ip2 flowing through the PMOS transistor 56 changes in the same manner as is the case with the load current IL2. Since the temperature Tx2 of the power supply IC 21 changes according to the current Ip2 as described above, the temperature Tx2 is the highest at time t11.

A description will then be given of waveforms of the switching power supply circuit 10. Since the load 11 becomes heavier at time t10, the output voltage Vout1 is reduced and the load current IL11 is increased. When the output voltage Vout1 is reduced from the voltage V1, the switching power supply circuit 10 allows the ON-period of the PMOS transistor 56 to become longer to increase the output voltage Vout1. Therefore, the temperature Tx1 of the power supply IC 20 rises. If the temperature Tx1 rises, the power supply IC 20 controls the NMOS transistor 55 and the PMOS transistor 56 so as to prevent the temperature Tx1 from rising as described above. That is, the power supply IC 20 controls the PMOS transistor 56 so that the ON-period of the PMOS transistor 56 becomes shorter. Therefore, the duty ratio of the signal Vp of the power supply IC 20 becomes smaller than the duty ratio of the signal Vp of the power supply IC 21. As a result, even if the load 11 changes, the temperature Tx1 becomes smaller than the temperature Tx2 and the output voltage Vout1 is reduced to become lower than the output voltage Vout2, as depicted in FIG. 5. The load currents IL1, IL2 are determined by the output voltages Vout1, Vout2 which are applied to the load 11 and the state of the load 11 (a substantial resistance value of the load 11). Therefore, the load current IL1 becomes smaller than the load current IL2.

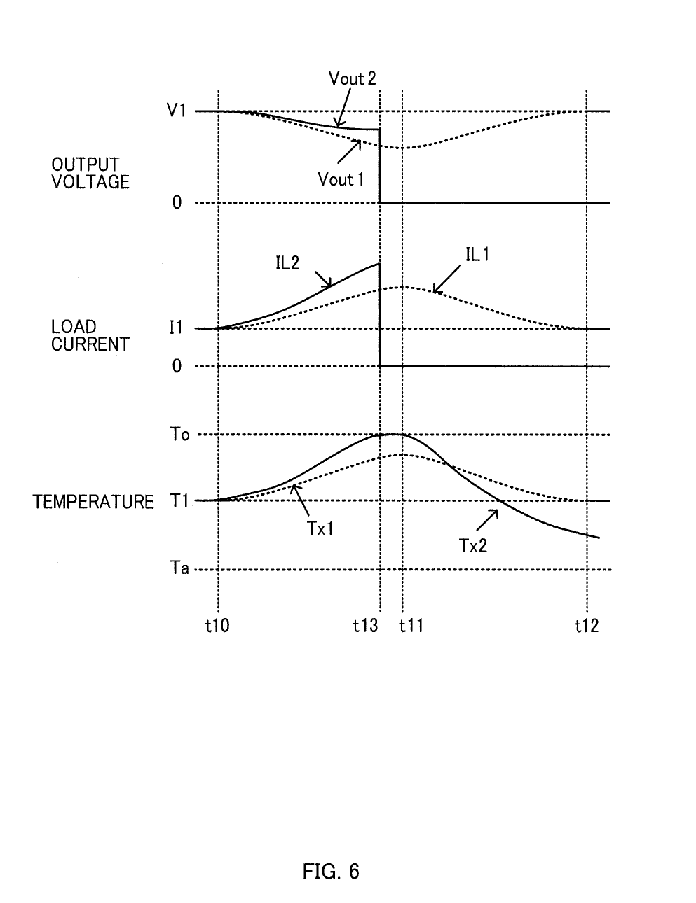

A description will then be given of the case where the temperature Tx2 reaches the operating temperature To of the overheat protection circuit 51 at time t13, as depicted in FIG. 6, for example. When the temperature Tx2 reaches the operating temperature To, the power supply IC 21 stops the switching operation. Therefore, the output voltage Vout2 becomes substantially zero, and the load current IL2 to be supplied to the load 11 also becomes substantially zero. When the switching operation is stopped, the temperature Tx2 of the power supply IC 21 changes in such a manner as to become closer to the ambient temperature Ta. On the other hand, the temperature Tx2 of the power supply IC 20 is lower than the temperature Tx1, the power supply IC 20 continues the switching operation. As such, in the switching power supply circuit 10, if the load 11 changes, an ability to drive the load 11 (output voltage, load current) is lower than the switching power supply circuit 12, as depicted in FIG. 5, for example. However, as depicted in FIG. 6, the switching power supply circuit 10 operates so as to prevent the temperature Tx1 from changing, and the temperature Tx1 becomes lower than the temperature Tx2. Therefore, the switching power supply circuit 10 can reduce the possibility that the overheat protection circuit 51 operates when the load 11 abruptly changes. Therefore, the switching power supply circuit 10 can drive the load 11 in a more stable manner than the typical switching power supply circuit 12.

### Second Embodiment of Switching Power Supply Circuit

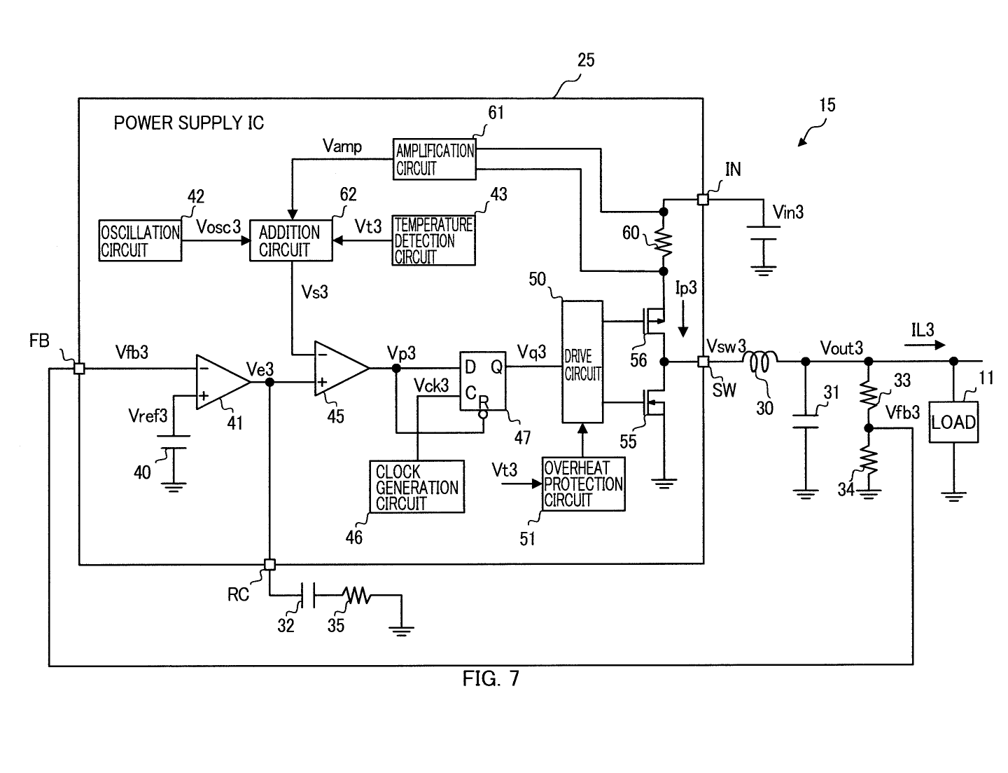

FIG. 7 depicts a configuration of a switching power supply circuit 15 according to one embodiment of the present invention. The switching power supply circuit 15 is a circuit that generates a desired output voltage Vout3 from an input voltage Vin3, for example, and includes a power supply IC 25, the inductor 30, the capacitors 31, 32, and the resistors 33 to 35. The power supply IC 25 (switching control circuit) is a so-called current-mode power supply IC, and includes the reference voltage circuit 40, the error amplification circuit 41, the oscillation circuit 42, the temperature detection circuit 43, the comparator 45, the clock generation circuit 46, the D-flip-flop 47, the drive circuit 50, the overheat protection circuit 51, the NMOS transistor 55, the PMOS transistor 56, a current detection resistor 60, an amplification circuit 61, and an addition circuit 62. The same components equivalent to those in the switching power supply circuit 10 depicted in FIG. 1 are designated by the same reference numerals in the switching power supply circuit 15 depicted in FIG. 7. The voltages, etc., of the nodes equivalent to those in the power source IC 20 are designated by the same reference numerals in the power source IC 25. Since only the current detection resistor 60, the amplification circuit 61, and the addition circuit 62 are different components when comparing between the power source IC 20 and the power source IC 25, a description will be given of the different components therebetween. The current detection resistor 60 and the amplification circuit 61 correspond to a current detection circuit.

The current detection resistor 60 is a resistor that detects a current IP3 flowing through the PMOS transistor 56.

The amplification circuit 61 amplifies a voltage generated at both ends of the current detection resistor 60, and outputs a voltage Vamp (detection voltage) corresponding to the current value of the current Ip3.

The addition circuit 62 adds a voltage level of the voltage Vamp, a voltage level of an oscillation signal Vosc3, and a voltage level of a temperature voltage Vt3. The addition circuit 62 outputs a voltage Vs3 as an addition result.

### Operation of Switching Power Supply Circuit 15 in Constant Temperature

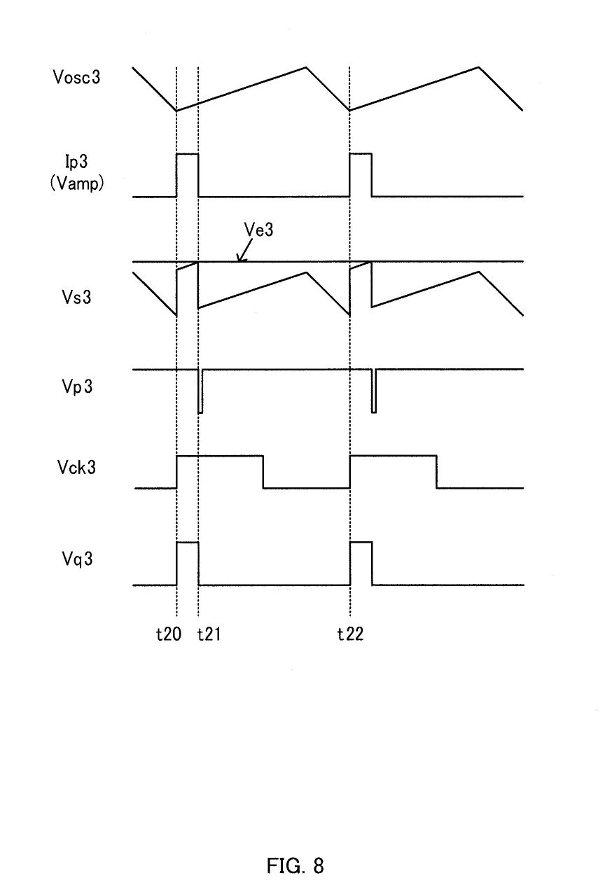

A description will be given of an operation of the switching power supply circuit 15 when the temperature Tx3 of the power supply IC 25 is constant, with reference to FIG. 8. Since it is assumed that the temperature Tx3 of the power supply IC 25 is constant, the voltage Vt3 and the direct-current level of the voltage Vs3 are constant. It is also assumed that the switching power supply circuit 15 generates the output voltage Vout3 of a desired level.

Since the voltage Vs3 is lower than the voltage Ve3 before time t20, the PWM signal Vp3 is high. When the clock signal Vck3 goes high at time t20, the drive signal Vq3 goes high. Therefore, the NMOS transistor 55 is turned off and the PMOS transistor 56 is turned on. Since the current Ip of the PMOS transistor 56 flows when the PMOS transistor 56 is turned on, the voltage Vamp is increased. Therefore, the voltage Vs3 rises in level.

When the voltage Vs3 becomes higher than the voltage Ve3 at time t21, the PWM signal Vp3 goes low. As a result, the D-flip-flop 47 is reset and the drive signal Vq3 goes low. Therefore, the PMOS transistor 56 is turned off and the current Ip3 becomes zero. When the clock signal Vck3 goes high at time t22, the PWM signal Vp3 goes high as is the case with time t20. The operation of from time t20 to t22 is repeated at time t22 and thereafter.

For example, if the output voltage Vout3 is increased, a feedback voltage Vfb3 is also increased. If the feedback voltage Vfb3 becomes greater than the reference voltage Vref3, the voltage Ve3 is reduced and the duty ratio of the drive signal Vq3 is also reduced. Therefore, the increased output voltage Vout3 and feedback voltage Vfb3 are reduced. On the other hand, if the output voltage Vout3 is reduced, the feedback voltage Vfb3 is also reduced. If the feedback voltage Vfb3 becomes smaller than the reference voltage Vref3, the voltage Ve3 is increased and the duty ratio of the drive signal Vq3 is also increased. Therefore, the reduced output voltage Vout3 and feedback voltage Vfb3 are increased. As such, the feedback voltage Vfb3 is in the feedback control so as to become equal to the reference voltage Vref3. Therefore, the switching power supply circuit 15 continuously generates the desired voltage Vout3.

### Operation of Switching Power Supply Circuit 15 in Gradually Changing Temperature

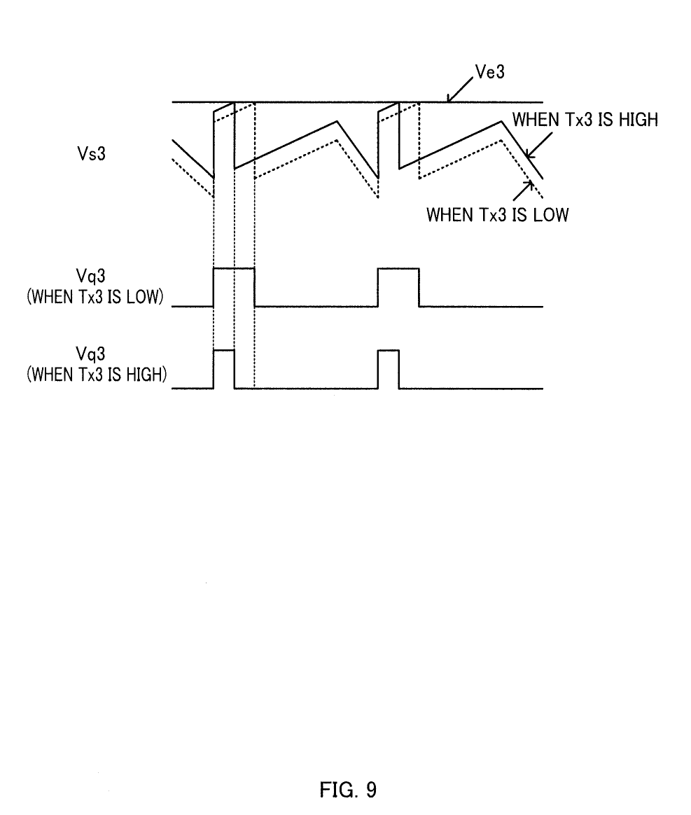

A description will be given of an operation of the switching power supply circuit 15 when the temperature of the power supply IC 25 gradually changes, with reference to FIG. 9. Here, it is assumed that the output voltage Vout3 of the switching power supply circuit 15 is controlled so as to be at a desired level.

For example, if the ambient temperature Ta rises, the temperature Tx3 of the power supply IC 25 also rises, and thus the temperature voltage Vt3 is increased. Therefore, the direct-current level of the voltage Vs3 is increased and the duty ratio of the drive signal Vq3 is reduced. If the duty ratio of the drive signal Vq3 is reduced, the output voltage Vout3 is reduced, and therefore the feedback voltage Vfb3 is also reduced. As described above, the feedback voltage Vfb3 is in the feedback control so as to become equal to the reference voltage Vref3. An embodiment of the present invention is designed such that the response speed of the switching power supply circuit 15 becomes faster, to a sufficient degree, than the change in the ambient temperature Ta. Therefore, practically, if the direct current level of the voltage Vs3 is increased, the power supply IC 25 immediately increases the level of the voltage Ve3 so that the feedback voltage Vfb3 becomes equal to the reference voltage Vref3. Thus, in an embodiment of the present invention, the duty ratio of the drive signal Vq3 does not substantially change and the duty ratio of the drive signal Vq3 is kept constant. The same applies to the case that the ambient temperature Ta falls. As such, if a change in temperature is gradual, the switching power supply circuit 15 continuously generates the desired output voltage Vout3.

### Operation of Switching Power Supply Circuit 15 in Abruptly Changing Temperature

A description will be given of an operation of the switching power supply circuit 15 when the temperature of the power supply IC 25 abruptly changes. If the temperature Tx3 abruptly rises, the duty ratio of the drive signal Vq3 is reduced as exemplified in FIG. 9. Therefore, the ON-period of the PMOS transistor 56 becomes shorter and the current Ip3 is reduced which is supplied from the PMOS transistor 56 to the terminal SW. The temperature Tx3 of the power supply IC 25 changes according to the current Ip3 as is the case with the temperature Tx1. Therefore, if the temperature Tx3 abruptly rises, the rise in the temperature Tx1 is suppressed. On the other hand, if the temperature Tx3 abruptly falls, the duty ratio of the drive signal Vq3 is increased. Therefore, the ON-period of the PMOS transistor 56 becomes longer and the current Ip3 is increased. That is, if the temperature Tx3 abruptly falls, the fall in the temperature Tx3 is suppressed. As such, if the temperature Tx3 abruptly changes, the switching power supply circuit 15 operates in such a manner as to prevent the change in the temperature Tx3.

Therefore, an abrupt change in temperature is unlikely to occur in the switching power supply circuit 15 as compared to a typical switching power supply circuit (not depicted) using a typical current-mode power supply IC.

Therefore, the switching power supply circuit 15 can reduce the possibility that the overheat protection circuit 51 operates when the load 11 abruptly changes, and thus, the switching power supply circuit 15 can continue driving the load 11 in a more stable manner than the typical switching power supply circuit.

### First Embodiment of Power Supply Apparatus

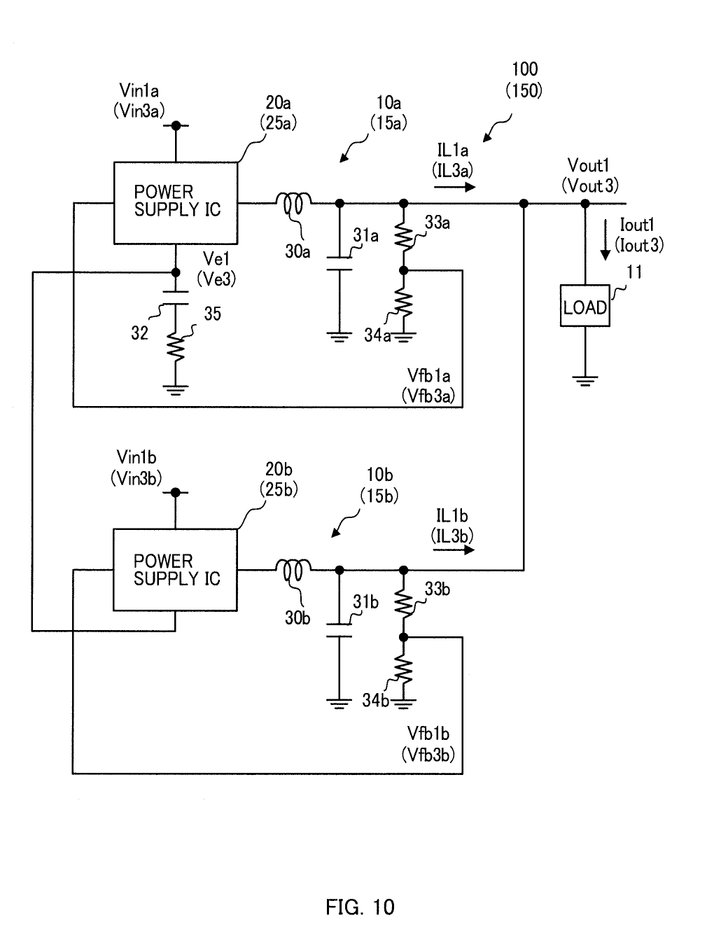

FIG. 10 depicts a configuration of a power supply apparatus 100 according to one embodiment of the present invention. The power supply apparatus 100 is an apparatus that supplies a desired output voltage to the load 11 and includes the two switching power supply circuits 10 connected in parallel. In an embodiment of the present, one of the two switching power supply circuits 10 is referred to as a switching power supply circuit 10a and the other is referred to as a switching power supply circuit 10b in order to distinguish therebetween. In the following description, “a” and “b” added to reference numerals are for the purpose of distinguishing the same components.

The switching power supply circuit 10a includes a power supply IC 20a, an inductor 30a, capacitors 31a, 32, and resistors 33a, 34a, and 35. The power supply IC 20a is the same as the power supply IC 20 depicted in FIG. 1, as described above. Therefore, although not particularly depicted in the figure, it is assumed that “a” is added to the reference numerals of the components included in the power supply IC 20a.

The switching power supply circuit 10b includes a power supply IC 20b, an inductor 30b, capacitors 31b, 32, and resistors 33b, 34b, and 35. It is assumed that “b” is similarly added to the reference numerals of the components included in the power supply IC 20b. The switching power supply circuits 10a, 10b share the capacitor 32 and the resistor 35 to drive the same load 11. The switching power supply circuits 10a, 10b operate in parallel.

In the power supply apparatus 100, a voltage Ve1 is a voltage of a node connecting the terminal RC (not depicted) of each of the power supply ICs 20a, 20b and the capacitor 32; Vout1 denotes a common output voltage of the switching power supply circuits 10a, 10b; and Iout1 denotes a load current of the load 11. Therefore, Iout1 denotes a sum of a load current IL1a from the switching power supply circuit 10a and a load current IL1b from the switching power supply circuit 10b. Further, TA1 denotes the temperature of the power supply IC 20a and TA2 denotes the temperature of the power supply IC 20b.

The voltages, etc., of the nodes in the switching power supply circuits 10a, 10b other than above are equivalent to the voltages, etc., of the nodes in the switching power supply circuit 10.

### Operation of Power Supply Apparatus 100

A description will be given of an operation of the power supply apparatus 100 when the temperature TA1 is higher than the temperature TA2, with reference to FIG. 1. A state where the temperature TA1 is higher than the temperature TA2 occurs in a case where the load current IL1a is greater than the load current IL1b while the ambient temperatures of the power supply ICs 20a, 20b are the same, or in a case where the ambient temperature of the power supply IC 20a is higher than the ambient temperature of the power supply IC 20b while the load currents IL1a, IL1b are the same, for example. The state where a difference occurs between the ambient temperatures is considered in the case where a high-temperature CPU (not depicted), etc., is located in the close vicinity of the power supply IC 20a while a circuit which generates heat is not particularly located around the power supply IC 20b, for example.

Since the temperature TA1 is higher than the temperature

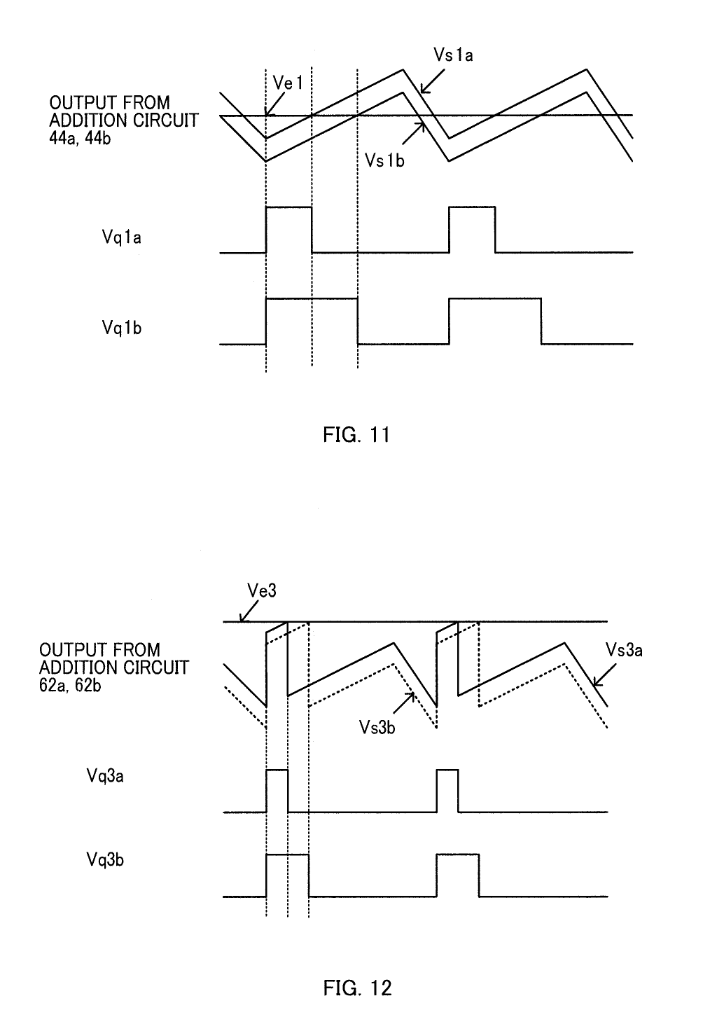

TA2, as depicted in FIG. 11, a direct current level of a voltage Vs1a from an addition circuit 44a in the power supply IC 20a is higher than a direct current level of a voltage Vs1b from an addition circuit 44b in the power supply IC 20b. Since the voltage Ve1 is a common voltage, a duty ratio of a drive signal Vq1a of the power supply IC 20a is smaller than a duty ratio of a drive signal Vq1b of the power supply IC 20b. As a result, the load current IL1a becomes smaller than the load current IL1b and the temperature TA1 falls while the temperature TA2 rises. That is, the power supply apparatus 100 according to an embodiment of the present invention operates so as to reduce a difference between the temperature TA1 and the temperature TA2 while generating the desired output voltage Vout1.

### Second Embodiment of Power Supply Apparatus

A power supply apparatus 150 according to one embodiment of the present invention will be described with reference to FIG. 10. The power supply apparatus 150 is an apparatus that supplies a desired output voltage to the load 11 and includes the two switching power supply circuits 15 connected in parallel. In an embodiment of the present invention, one of the two switching power supply circuits 15 is referred to as a switching power supply circuit 15a and the other is referred to as a switching power supply circuit 15b in order to distinguish therebetween. The power supply apparatus 150 is similar to the power supply apparatus 100 except that power supply ICs 25a, 25b are used instead of the power supply ICs 20a, 20b in the power supply apparatus 100.

The switching power supply circuit 15a includes the power supply IC 25a, the inductor 30a, the capacitors 31a, 32, and the resistors 33a, 34a, and 35. The power supply IC 25a is similar to the power supply IC 25 depicted in FIG. 1, as described above. The switching power supply circuit 15b includes the power supply IC 25b, the inductor 30b, the capacitors 31b, 32, and the resistors 33b, 34b, and 35. The switching power supply circuits 15a, 15b share the capacitor 32 and the resistor 35 to drive the same load 11. The switching power supplies 15a, 15b operate in parallel.

In the power supply apparatus 150, a voltage Ve3 is a voltage of a node connecting the terminal RC (not depicted) of each of the power supply ICs 25a, 25b and the capacitor 32; Vout3 denotes a common output voltage of the switching power supply circuits 10a, 10b; and Iout3 denotes a load current of the load 11. Further, TB1 denotes the temperature of the power supply IC 25a and TB2 denotes the temperature of the power supply IC 25b.

The voltages, etc., of the nodes in the switching power supply circuits 15a, 15b other than above are equivalent to the voltages, etc., of the nodes in the switching power supply circuit 15.

### Operation of Power Supply Apparatus 150

A description will be given of an operation of the power supply apparatus 150 when the temperature TB1 is higher than the temperature TB2, with reference to FIG. 7.

Since the temperature TB1 is higher than the temperature TB2, a direct current level of a voltage Vs3a from an addition circuit 62a in the power supply IC 25a is higher than a direct current level of a voltage Vs3b from an addition circuit 62b in the power supply IC 25b, as depicted in FIG. 12. Since the voltage Ve3 is a common voltage, a duty ratio of the drive signal Vq3a of the power supply IC 25a is smaller than a duty ratio of a drive signal Vq3b of the power supply IC 25b. As a result, the load current IL3a becomes smaller than the load current IL3b and the temperature TB1 falls while the temperature TB2 rises. That is, the power supply apparatus 150 according to an embodiment of the present invention operates so as to reduce a difference between the temperature TB1 and the temperature TB2 while generating the desired output voltage Vout3.

### Third Embodiment of Power Supply Apparatus

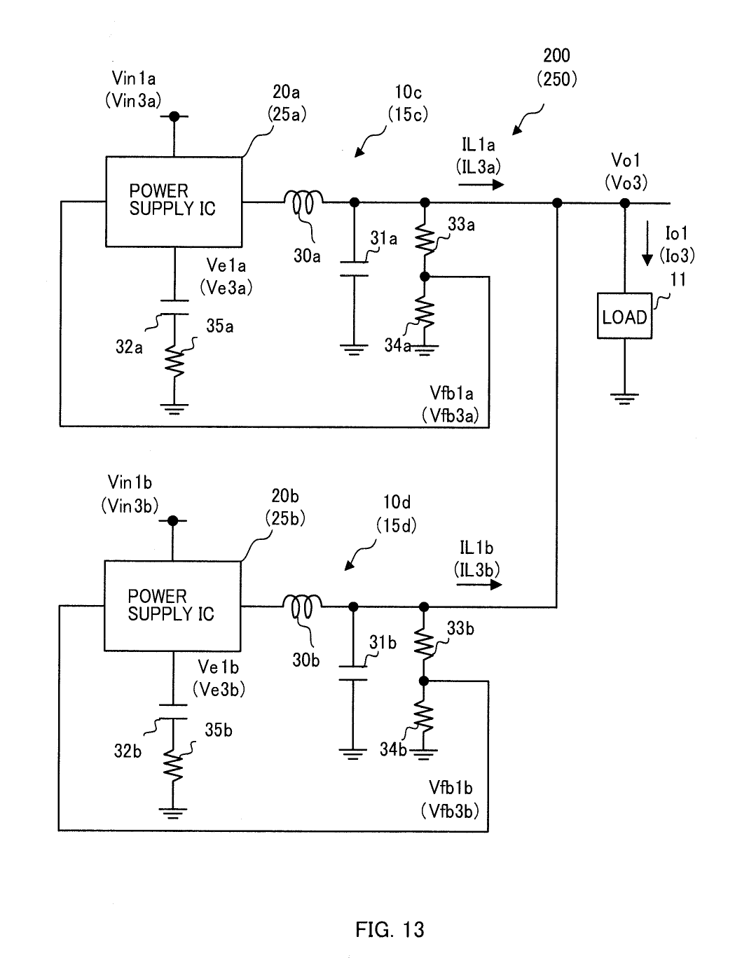

A power supply apparatus 200 according to one embodiment of the present invention will be described with reference to FIG. 13. The power supply apparatus 200 is an apparatus that supplies a desired output voltage to the load 11 and includes the two switching power supply circuits 10 connected in parallel. Switching power supply circuits 10c, 10d are similar to the switching power supply circuits 10a, 10b except that each includes the condenser 32 and the resistor 35.

The switching power supply circuit 10c includes a power supply IC 20a, the inductor 30a, the capacitors 31a, 32a, and the resistors 33a to 35a. The switching power supply circuit 10d includes a power supply IC 20b, the inductor 30b, the capacitors 31b, 32b, and the resistors 33b to 35b. Vo1 denotes a common output voltage of the switching power supply circuits 10c, 10d, and Io1 denotes a load current of the load 11. As is the case with the power supply apparatus 100, TA1 denotes the temperature of the power supply IC 20a and TA2 denotes the temperature of the power supply IC 20b.

### Operation of Power Supply Apparatus 200

A description will be given of an operation of the power supply apparatus 200 in a case where only the temperature TA1 rises after the initial state in which both the temperatures TA1 and TA2 are set at a predetermined temperature, with reference to FIG. 1.

If the temperature TA1 rises, the direct current level of the voltage Vs1a from the addition circuit 44a in the power supply IC 20a is increased. As a result, the duty ratio of the drive signal Vq1a of the power supply IC 20a becomes smaller and the output voltage Vo1 is reduced. If the output voltage Vo1 is reduced, both feedback voltages Vfb1a and Vfb1b are reduced. Therefore, the power supply ICs 20a, 20b increase voltages Ve1a, Ve1b so as to allow the feedback voltages Vfb1a and Vfb1b to become equal to reference voltages Vref1a and Vref1b, respectively.

For example, as in the case of the switching power supply circuit 10, when only the switching power supply circuit 10 performs control so as to increase the output voltage Vout1 which has been reduced due to the rise in the temperature Tx1, the power supply IC 20 is required to output the drive signal Vq1 with the same duty ratio before and after the change in the temperature Tx1. However, in the power supply apparatus 200, when the temperature TA1 rises and the output voltage Vo1 is reduced, not only the power supply IC 20a but also the power supply IC 20b operates so as to increase the output voltage Vo1, as described above. Since the temperature TA2 is constant, the direct current level of the voltage Vs1b from the addition circuit 44b of the power supply IC 20b does not change. Therefore, if the voltage Ve1b is increased, the duty ratio of the drive signal Vg1b of the power supply IC 20b is increased to become greater than that before the rise in the temperature TA1. Therefore, the desired level of the output voltage Vo1 is generated while the drive signal Vg1a, whose duty ratio is smaller than that before the rise in the temperature TA1, is generated.

As described above, if the temperature TA1 rises, the duty ratio of the drive signal Vg1a becomes smaller than that before the rise in the temperature TA1, and the duty ratio of the drive signal Vg1b becomes greater than that before the rise in the temperature TA1. Therefore, the power supply apparatus 200 according to an embodiment of the present invention operates so as to reduce a difference between the temperature TA1 and the temperature TA2, while generating the desired output voltage Vout1.

### Fourth Embodiment of Power Supply Apparatus

A power supply apparatus 250 according to one embodiment of the present invention will be described with reference to FIG. 13. The power supply apparatus 250 is an apparatus that supplies a desired output voltage to the load 11 and includes the two switching power supply circuits 15 connected in parallel. The power supply apparatus 250 is similar to the power supply apparatus 200 except that the power supply ICs 25a, 25b are used in place of the power supply ICs 20a, 20b in the power supply apparatus 200.

The power supply ICs 25a, 25b, respectively, operate in response to changes in temperatures thereof in the same manner as is the case with the power supply ICs 20a, 20b. Therefore, for example, when only the temperature of the power supply IC 25a rises, the power supply apparatus 250 operates so as to reduce a difference in temperature between the power supply IC 25a and the power supply IC 25b.

The power supply IC 20 according to an embodiment of the present invention as described above operates so as to prevent a change in the temperature Tx1 if the temperature Tx1 abruptly changes. For example, when the load 11 becomes heavier in the switching power supply circuit 10, the rise in the temperature Tx is suppressed. As a result, such possibility is reduced that the temperature Tx reaches the temperature To at which the overheat protection circuit 51 is activated. Therefore, the number of times the power supply IC 20 stops the switching operation is reduced, and thus the switching power supply circuit 10 can drive the load 11 in a stable manner.

The power supply IC 20 compares the voltage Vs1, whose direct current level is changed with the temperature Tx1, to the voltage Ve1 of the error amplification circuit 41, which generates an error between the feedback voltage Vfb1 and the reference voltage Vref1. The voltage Ve1 changes according to the response speed in the loop band of the feedback loop of the feedback voltage Vfb1. Therefore, if the temperature Tx1 changes gradually and the direct current level of the voltage Vs1 changes more slowly, to a sufficient degree, as compared to the response speed, the switching power supply circuit 10 does not prevent the change in the temperature Tx1. Therefore, for example, if the ambient temperature Ta increases gradually, the temperature Tx1 increases in the same manner as is the case with the ambient temperature Ta. When the temperature Tx1 reaches the temperature To, the overheat protection circuit 51 is activated. Therefore, if the ambient temperature Ta, etc., rise and the possibility of thermal destruction is increased, the overheat protection circuit 51 can reliably be activated.

In the power supply IC 20, the addition circuit 44 adds a level of the temperature voltage Vt1, whose direct current level is changed with the temperature Tx1, to the voltage level of the oscillation signal Vosc1. With such a configuration, the voltage Vs1, whose direct current level is changed with the temperature Tx1, is generated.

In the power supply IC 25, the voltage Vamp corresponding to the current Ip3 of the PMOS transistor 56 is input to the addition circuit 62, other than the oscillation signal Vosc3 and the temperature voltage Vt3. Therefore, the power supply IC 25 operates as a so-called current-mode power supply IC. The power supply IC 25 operates in response to a change in the temperature Tx3 in the same manner as is the case with the power supply IC 20. Therefore, the switching power supply circuit 15 can drive the load 11 in a stable manner as is the case with the switching power supply circuit 10.

For example, the power supply apparatus 200 operates so as to reduce a difference between the temperature TA1 of the power supply IC 20a and the temperature TA2 of the power supply IC 20b while generating the desired output voltage Vout1. That is, the power supply apparatus 200 operates so as to average the temperature TA1 and the temperature TA2. Therefore, even if the temperature is high in one of the power supply ICs 20a and 20b, the possibility is reduced that the overheat protection circuit 51 stops the operation of one of the ICs. Therefore, the power supply apparatus 200 can drive the load 11 in a stable manner.

For example, in the power supply apparatus 200, the switching power supply circuits 10c, 10d have the same configuration. However, due to production variations in the power supply ICs 20a, 20b, external parts, etc., the switching power supply circuits 10c, 10d vary in response speed. Therefore, the switching power supply circuit 10c may be faster in response speed than the switching power supply circuit 10d. In such a case, for example, even if the temperature TA1 rises and the output voltage Vo1 is reduced, only the voltage Ve1a with the faster response speed may rise. Therefore, it becomes difficult to average the heat generation of the power supply ICs 20a, 20b. However, for example, the power supply apparatus 100 has the RC terminal common to the power supply ICs 20a, 20b. Therefore, for example, when the temperature TA1 rises, the duty ratio of the drive signal Vq1a reliably becomes smaller than that before the rise in the temperature TA1 and the duty ratio of the drive signal Vq1b becomes greater than that before the rise in the temperature TA1. Therefore, the power supply apparatus 100 can reduce a difference between the temperature TA1 and the temperature TA2 in a more reliable manner while generating the desired output voltage Vout1.

The above embodiments of the present invention are simply for facilitating the understanding of the present invention and are not in any way to be construed as limiting the present invention. The present invention may variously be changed or altered without departing from its spirit and encompass equivalents thereof.

Although the direct current level of the voltage Vs1 changes with the temperature Tx1 in the power supply IC 20, this is not a limitative. For example, a variable resistance circuit may be provided that changes the direct current level of the voltage Ve according to temperature (e.g., circuit that changes a pressure division ratio according to the voltage Vt1). If the output of the variable resistance circuit is applied to the non-inverting input terminal of the comparator 45, and for example, the oscillation signal Vosc1 is applied to the inverting input terminal of the comparator 45, the duty ratio of the drive signal Vq1 can be changed with the temperature Tx1 as is the case with the power supply IC 20.

The power supply ICs 20a and 20b share the capacitor 32 and the resistor 35 in the power supply apparatus 100, for example, however, each of the power supply ICs 20a and 20b may have the capacitor 32 and the resistor 35. Even in this case, if the RC terminals of the power supply ICs 20a and 20b are connected, an operation can be performed as in the same manner as in the case with the power supply apparatus 100.

The external parts for phase compensation of the power supply IC 20, such as the capacitor 32, may be provided in the power supply IC 20.

Although the oscillation signal Vosc1 has a sawtooth waveform, the oscillation signal Vosc1 may have a triangular waveform or an inverse sawtooth waveform, for example.

What is claimed is:

1. A switching control circuit comprising:
a drive circuit configured to turn on/off a transistor according to a duty ratio of a drive signal so as to generate an output voltage of a target level from an input voltage, the transistor configured to be applied with the input voltage at an input electrode thereof; and
a drive signal generation circuit configured to change the duty ratio of the drive signal based on a reference voltage and a feedback voltage corresponding to the output voltage,
to generate the drive signal having the duty ratio which is changed so that the feedback voltage becomes equal in level to the reference voltage, and which is changed so that the output voltage is reduced with a rise in temperature.

2. A switching control circuit comprising:
a drive circuit configured to turn on/off a transistor according to a duty ratio of a drive signal so as to generate an output voltage of a target level from an input voltage, the transistor configured to be applied with the input voltage at an input electrode thereof; and
a drive signal generation circuit configured to change the duty ratio of the drive signal based on a reference voltage and a feedback voltage corresponding to the output voltage,
to generate the drive signal having the duty ratio which is changed so that the feedback voltage becomes equal in level to the reference voltage,
the drive signal generation circuit including
an error amplification circuit configured to generate an error voltage corresponding to an error between the reference voltage and the feedback voltage,
an oscillation signal output circuit configured to output a triangular-wave oscillation signal oscillating around a direct current level with a predetermined period, and change the direct current level according to a change in temperature, and
a drive signal output circuit configured to output the drive signal whose duty ratio causes the feedback voltage to become equal in level to the reference voltage, based on a magnitude relation between the error voltage and the oscillation signal.

3. The switching control circuit of claim 2, wherein
the oscillation signal output circuit includes
an oscillation circuit configured to generate a triangular-wave oscillation signal oscillating around the direct current level with the predetermined period,
a temperature voltage generation circuit configured to generate a temperature voltage of a voltage level corresponding to a temperature, and
an addition circuit configured to add a voltage level of the output signal and a voltage level of the temperature voltage, and output an obtained addition result as the oscillation signal, so that the output voltage is reduced with a rise in temperature.

4. The switching control circuit of claim 3, further comprising
a current detection circuit configured to detect a current flowing through the transistor and output a detection voltage corresponding to a detection result, wherein
the addition circuit configured to add the output signal, the temperature voltage, and the detection voltage, and output an obtained addition result as the oscillation signal, so that the output voltage is reduced with a rise in temperature or an increase in the current flowing through the transistor.

5. A power supply apparatus comprising:
a first switching power supply circuit including
a first drive circuit configured to turn on/off a first transistor according to a duty ratio of a first drive signal so as to generate an output voltage of a target level from a first input voltage, the first transistor configured to be applied with the first input voltage at an input electrode thereof, and
a first drive signal generation circuit configured to change the duty ratio of the first drive signal based on a first reference voltage and a first feedback voltage corresponding to the output voltage,
to generate the first drive signal having the duty ratio which is changed so that the first feedback voltage becomes equal in level to the first reference voltage, and which is changed so that the output voltage is reduced with a rise in temperature; and
a second switching power supply circuit including
a second drive circuit configured to turn on/off a second transistor according to a duty ratio of a second drive signal so as to generate the output voltage from a second input voltage, the second transistor configured to be applied with the second input voltage at an input electrode thereof, and
a second drive signal generation circuit configured to change the duty ratio of the second drive signal based on a second reference voltage and a second feedback voltage corresponding to the output voltage,
to generate the second drive signal having the duty ratio which is changed so that the second feedback voltage becomes equal in level to the second reference voltage, and which is changed so that the output voltage is reduced with a rise in temperature.

6. A power supply apparatus comprising:
a first switching power supply circuit including
a first drive circuit configured to turn on/off a first transistor according to a duty ratio of a first drive signal so as to generate an output voltage of a target level from a first input voltage, the first transistor configured to be applied with the first input voltage at an input electrode thereof, and
a first drive signal generation circuit configured to change the duty ratio of the first drive signal based on a first reference voltage and a first feedback voltage corresponding to the output voltage,
to generate the first drive signal having the duty ratio which is changed so that the first feedback voltage becomes equal in level to the first reference voltage; and
a second switching power supply circuit including
a second drive circuit configured to turn on/off a second transistor according to a duty ratio of a second drive signal to generate the output voltage from a second input voltage, the second transistor configured to be applied with the second input voltage at an input electrode thereof, and
a second drive signal generation circuit configured to change the duty ratio of the second drive signal based on a second reference voltage and a second feedback voltage corresponding to the output voltage,
to generate the second drive signal having the duty ratio which is changed so that the second feedback voltage becomes equal in level to the second reference voltage,
the first drive signal generation circuit including
a first error amplification circuit configured to charge/discharge a capacitor according to a difference between the first reference voltage and the first feedback voltage,
a first oscillation signal output circuit configured to output a first triangular-wave oscillation signal oscillating around a direct current level with a predetermined period, and change the direct current level according to a change in temperature, and
a first drive signal output circuit configured to output the first drive signal whose duty ratio causes the first feedback voltage to become equal in level to the first reference voltage, based on a magnitude relation between a charging voltage of the capacitor and the first oscillation signal,
the second drive signal generation circuit including
a second error amplification circuit configured to charge/discharge the capacitor according to a difference between the second reference voltage and the second feedback voltage,
a second oscillation signal output circuit configured to output a second triangular-wave oscillation signal oscillating around a direct current level with a predetermined period, and change the direct current level according to a change in temperature, and
a second drive signal output circuit configured to output the second drive signal whose duty ratio causes the second feedback voltage to become equal in level to the second reference voltage, based on a magnitude relation between the charging voltage of the capacitor and the second oscillation signal.
